(19) United States
(12) Patent Application Publication
(10) Pub. No.: US 2009/0313097 A1
(43) Pub. Date: Dec. 17, 2009

(54) System and Method for Advertisers to Bid on Distributing Ads to Telephone Calling Parties

(75) Inventor: Koushik Chatterjee, Orlando, FL (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/139,107

(22) Filed: Jun. 13, 2008

(51) Int. Cl. G06Q 30/00

(52) U.S. Cl. 705/14.1; 705/10; 705/14.57

(57) ABSTRACT

A system and method of advertising to telephones may include enabling an advertiser to submit a bid for airtime to present an advertisement to callers who call one or more telephone numbers. A bid may be received from the advertiser to advertise to callers who place calls to the one or more telephone numbers. In response to callers placing telephone calls to the telephone number(s), the advertisement may be presented to the callers. The number of advertisements presented to callers may be counted and used for billing the advertiser.

### BACKGROUND

Telecommunications services have become significantly less expensive over the past few years for consumers. One way that telecommunication service providers have attempted to increase revenue to offset lower profit margins has been through providing customers with extra features, such as text messaging, photo messaging, downloadable ring tones, and advertising. Advertising to telephones has generally been through playing audio advertisements in response to a user requesting information, such as telephone directory information, or displaying visual advertisements on data network enabled telephones. Additional sources of revenue are desired by telecommunication service providers to increase profit margins.

### SUMMARY

To increase revenue by telecommunication service providers, the principles of the present invention provide for telecommunication service providers to enable advertisers to bid on the ability to present advertisements or ads to callers of telephone numbers. In one embodiment, the advertisers may select one or more categories, geographic regions, particular companies, or telephone numbers to present the advertisements. An assignee of a telephone number may be provided with the ability to limit ads that can be presented in response to a call being placed to the telephone number. Furthermore, a user may be provided with the ability to limit ads that can be presented to his or her telephone when placing a call. In one embodiment, an advertiser who bids the most amount of money per ad or per time duration (e.g., per day, week, or month), may “win” the ad time over other bidders of the same airtime. Thus, a caller who calls a particular telephone number or business may be presented an advertisement from an advertiser who wins the bid over another advertiser who bidded less.

One embodiment of a method of advertising to telephones may include enabling an advertiser to submit a bid for airtime to present an advertisement to callers who call one or more telephone numbers. A bid may be received from the advertiser to advertise to callers who place calls to the one or more telephone numbers. In response to callers placing telephone calls to the telephone number(s), the advertisement may be presented to the callers. The number of advertisements presented to callers may be counted and used for billing the advertiser.

One embodiment of a system for advertising to telephones may include a storage unit, at least one data repository, and a processing unit. The data repositories may be configured to store advertising content and at least one parameter associated with the advertising content. The parameter(s) may include an indicia associated with a telephone number. The processing unit may be in communication with the storage unit, and be configured to (i) enable an advertiser to submit a bid for airtime to present the advertising content to callers who call the telephone number, (ii) receive a bid from the advertiser to advertise to callers who place calls to the telephone number, (iii) in response to callers placing telephone calls to the telephone number, present the advertisement to the callers, and (iv) count the number of advertisements presented to the callers for use in billing the advertiser.

### BRIEF DESCRIPTION OF THE DRAWINGS

FIG. 1 is an illustration of an illustrative network environment configured to enable advertisers to submit bids to win airtime to present advertisements to callers of telephone numbers;

FIG. 2A-2C are screenshots of illustrative graphical user interfaces for providing an advertiser with the ability to submit a bid on select telephone numbers, geographic regions, and other criteria for presenting advertisements to callers of telephone numbers;

FIG. 3 is a screenshot of an illustrative graphical user interface to enable an assignee of a telephone number to limit advertisements that can be presented to callers of the assignee's telephone number;

FIG. 4 is a screenshot of an illustrative graphical user interface that enables an assignee of a telephone number to limit advertisements presented to the assignee's telephone;

FIG. 5 is a block diagram of an illustrative server configured to provide for bidding on airtime to callers of telephone numbers by advertisers and presenting advertisements to callers of the telephone numbers in accordance with the principles of the present invention;

FIGS. 6A-6D are block diagrams of illustrative modules configured to provide advertisers with the ability to submit bids for airtime to callers of telephone numbers in accordance with the principles of the present invention;

FIG. 7 is a timing diagram of an illustrative process for selecting and presenting advertisements to callers of a telephone number; and

FIG. 8 is a flow diagram of an illustrative process for providing an advertiser with the ability to submit a bid for airtime to present ads to callers of a telephone number.

### DETAILED DESCRIPTION OF THE DRAWINGS

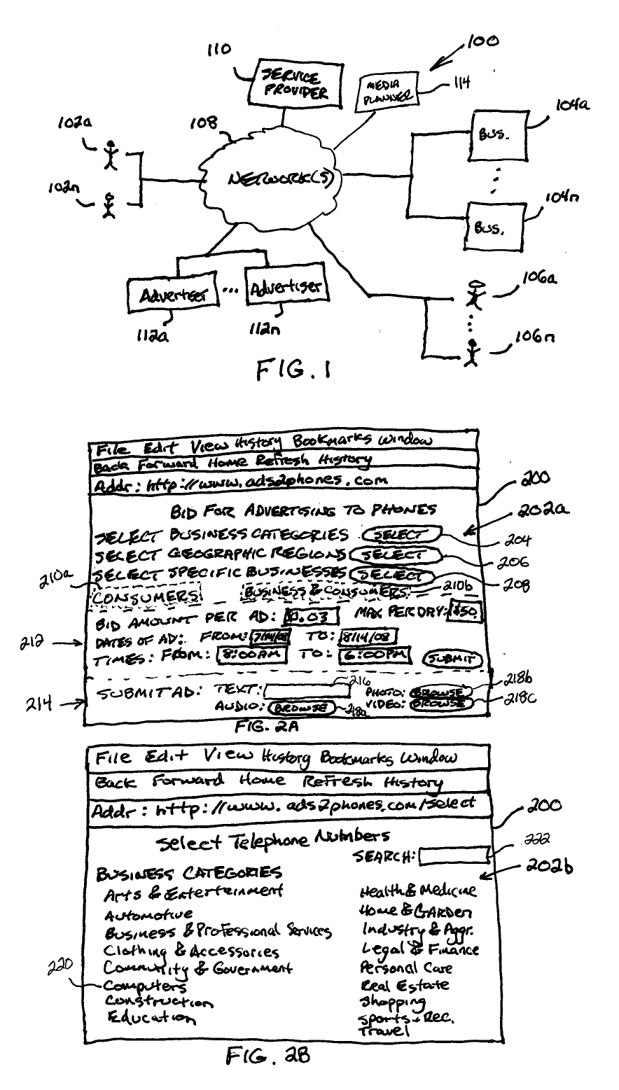

With regard to FIG. 1, a network environment 100 may include users or consumers 102a-102n (collectively 102) who call businesses 104a-104n (collectively 104). In addition, the consumers 102 may call other users 106a-106n (collectively 106) of telephones (not shown) via one or more network(s) 108. The network(s) 108 may include any telecommunications network, such as the public switched telephone network (PSTN), mobile telephone network, and the Internet. To provide for telecommunications services on the network(s) 108, a service provider 110 may enable the consumers 102, businesses 104, and users 106 to call one another using telephones by assigning telephone numbers to respective consumers 102, businesses 104, and users 106. As understood in the art, each of the telephone numbers may be designated with an area code (NPA) and exchange code (NXX), where a telephone number is formatted as NPA-NXX-(4 digits).

Advertisers 112a-112n (collectively 112) may be provided the opportunity to advertise to callers by the service provider 110 or media planner 114 that purchases airtime from the service provider 110. The “airtime” may be considered any time that is available during a telephone call, such as prior to a calling party being connected with a called party at the start of a telephone call. The media planner 114 may buy the airtime in bulk, such as a certain number of time segments, minutes, telephone numbers, etc., and sell the airtime to advertisers.

The advertisers 112 may purchase airtime from the service provider 110 or media planner 114 for telephone numbers associated with businesses 104 and/or users 106. With regard to the businesses 104, the advertisers may select to purchase airtime for telephone numbers associated with business categories, specific businesses, businesses within certain area codes, or any other way to categorize or identify businesses. With regard to the users 106, the advertisers may elect to advertise when callers call a specific user, users in a particular region, users with particular demographics, or any other way to categorize or identify users.

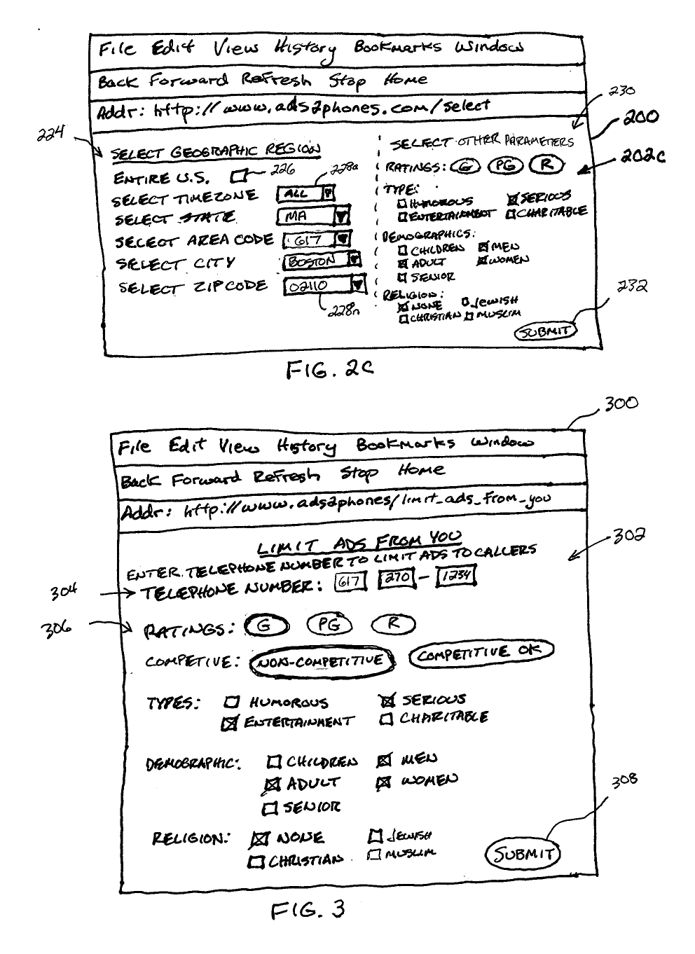

With regard to FIG. 2A, a web browser 200 may display a webpage 202a for an advertiser to bid airtime for presenting an advertisement to a caller when the caller calls a particular telephone number or a telephone number that meets a certain criteria, such as being assigned to a business within a particular business category. The bidding may be performed in an auction that has a particular time limit during which the auction is open for bids to be submitted. As shown, the advertiser may select a graphical user element 204 that enables the advertiser to select a business category for which the advertiser would like to advertise to callers to any business that is categorized within a selected business category. For example, an advertiser may select a category of pizza restaurants and any restaurant that is categorized within the pizza restaurant category may have the advertiser's advertisement presented to a caller of any pizza restaurant. To further narrow down an advertiser's customer targeting effort, the advertiser may select graphical user element 206 to enable the advertiser to specify one or more geographic regions within which callers who call pizza restaurants, for example, may be presented the advertiser's advertisement. If, for example, the advertiser has selected a business category (e.g., pizza restaurant) and geographic region (e.g., zip code), then the advertiser's advertisement may be played to any caller who called a pizza restaurant within the selected geographic region.

In one embodiment, an advertiser may select a graphical user element 208 to specify a specific business that the advertiser would like to deliver an advertisement to callers who call that particular business. For example, the advertiser may select a sporting goods store, automobile parts store, or any other store or business that might be associated with a product of the advertiser so as to target customers who might have a particular interest in the advertiser's product.

Furthermore, the advertiser may select (i) soft-button 210a to advertise only to consumers or (ii) soft-button 210b to advertise to both businesses and consumers. In one embodiment, an advertiser may select one or more geographic regions via graphical user element 206 and “consumers” or individuals via soft-button 210a and the advertisement of the advertiser will be presented only to callers who call consumers within the selected geographic region. The geographic region may be selected by country name, state name, county name, city or town name, zip code, area code, exchange code, or any other way to define a geographic region that may be identified or determined at the start of a telephone call.

The webpage 202a may include an ad bid section 212 that enables an advertiser to submit a bid for presenting ads to callers of a telephone number of a business, governmental entity, or individual, with date and time parameters within which the advertisement may be presented. As shown, a bid amount per ad may be three cents ($0.03) and have a maximum amount of dollars to be spent per day (e.g., $50.00). Alternatively, a maximum number of ad presentations may be selectable or enterable by an advertiser. The dates of an ad to be run may be submitted from a starting date to an ending date and include times of day that the advertiser wishes for their ads to be presented to callers. By enabling the advertiser to limit times of day and dates for the advertisement to be presented to callers, the advertiser may attempt to present the advertisement to callers who may have more of an interest in the advertiser's product. For example, the advertiser may limit the dates to weekdays and hours to business hours, such that callers to a particular business category (e.g., baby stores) may be presented with an advertisement for a product (e.g., diapers) to target housewives or other business day callers of the particular business category. It should be understood that a wide variety of examples for targeting consumers and business people may be readily understood by those skilled in the art of advertising.

The webpage 202a may further include an ad submission section 214 that an advertiser may use to submit an advertisement. The ad submission section 214 may include a text entry field 216 in which the advertiser may enter text for an advertisement to be presented to a caller in a text message, for example. Alternatively, the advertiser may select to upload audio, photograph, or video content by selecting from respective soft-buttons 218a-218c. Depending upon the format of the advertisement, a caller may be presented with the advertisement in each respective format. For example, if the advertiser submits or uploads an audio file, then a caller who called a business or consumer may be presented with an advertisement in the form of an audio advertisement delivered via the telephone. However, if the advertiser submits a photograph or video, a caller who is using a telephone configured to receive and display photographs or videos may receive the advertisement in that format. In one embodiment, a minimum bid may be varied based on the format of the advertisement, where an audio advertisement may have the lowest presentation charge (e.g., $0.01 per text ad presentation) and a video may have the highest presentation charge (e.g., $0.05 per video ad presentation).

With regard to FIG. 2B, the browser 200 is displaying a webpage 202b that includes a list of business categories from which an advertiser may select. Each of the titles in the list of business categories may be selectable. Upon selecting a business category, sub-categories may be presented to the advertiser via a hyperlink to further select or “drill down” within the business category. For example, a user who selects the computers business category 220, may be presented with another list that identifies sub-categories of the computer's business category 220, including manufacturers, resellers, repair shops, personal computers stores, mainframe computer stores, or any other sub-categories within the computers business category 220. In addition, a search text entry field 222 may be available for an advertiser to enter a search term of a business category or sub-category to assist the advertiser in identifying a business category or sub-category to advertise to callers of businesses in the selected business category or sub-category.

With regard to FIG. 2C, the browser 200 may display a webpage 202c. The webpage 202c may include a section 224 in which an advertiser may select geographic region(s) for presenting ads to callers who call into businesses or consumers within these selected region(s). As shown, the advertiser may select a graphical element 226 that indicates to advertise to any region within the United States. In addition, selection elements 228a-228n may be available for the advertiser to select time zones, state, area code, city, and zip code. It should be understood that any other form of identifying a geographic region may be provided to an advertiser to select.

The webpage 202c may also include another region 230 that enables an advertiser to select other parameters for limiting advertisements to be presented to callers. For example, the other parameters may include ratings (e.g., general (rated G), parental guidance (rated PG) and restricted (rated R)) that define the “age appropriateness” of the advertisement. Other factors or ratings may help define the age appropriateness of the advertisement, such as subject matter. An advertisement may be categorized as being humorous, entertainment, serious, charitable, or any other type that may give an indication as to the type of advertisement that the advertiser is submitting for presentation to callers. Furthermore, the advertiser may select demographics of consumers of whom the advertisement is suitable and with whom the advertiser is seeking to reach. Furthermore, another parameter may include religion that the advertiser considers the advertisement to be associated or related. The advertiser may complete selection of the various selections in the webpage 202c and select a “submit” soft-button 232 with submission of the geographic region and parameter selections.

In addition to collecting information from an advertiser to determine a type of advertisement and in what businesses or consumers to associate the advertisement for presenting to callers of those businesses and consumers, the businesses and consumers may be able to limit the types of advertisements that are presented to callers to the businesses and consumers. The reason for a business or consumer to want to limit advertisements from their telephone numbers is to avoid an advertisement that the business or consumer does not approve being presented to callers of the business or consumer. For example, an advertisement of a competitor may not be desirable for a business to have played to callers of the business. As another example, a pizza shop may not wish to have beer advertised to customers who call the pizza shop. Furthermore, businesses may not wish to have advertisements with “racy” or “risqué” subject matter that are not aligned with the business' core values.

With regard to FIG. 3, a web browser 300 may display a webpage 302 that enables a business or consumer to enter telephone number 304 and select from parameters 306 to define certain types of ads that may or may not be presented to callers of the telephone number 304. The parameters 306 may include ratings, whether or not the ad can be an ad of a competitor, types of ads, demographics of callers that the ads are indicated as being targeted, religion, or any other category or identifier from which an advertiser may select. Upon completion, the user may select a “submit” soft-button 308 to submit the parameter selections. The parameter selections may be used when a caller places a call to the telephone number to select an advertisement that meets the parameter selections to play from a caller to the telephone number 304.

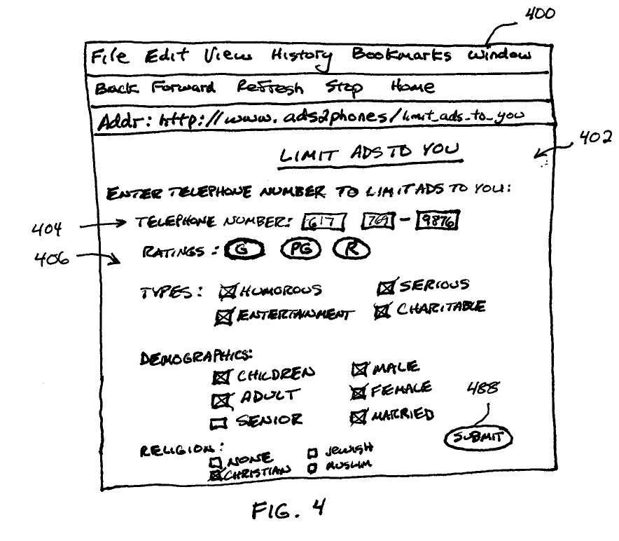

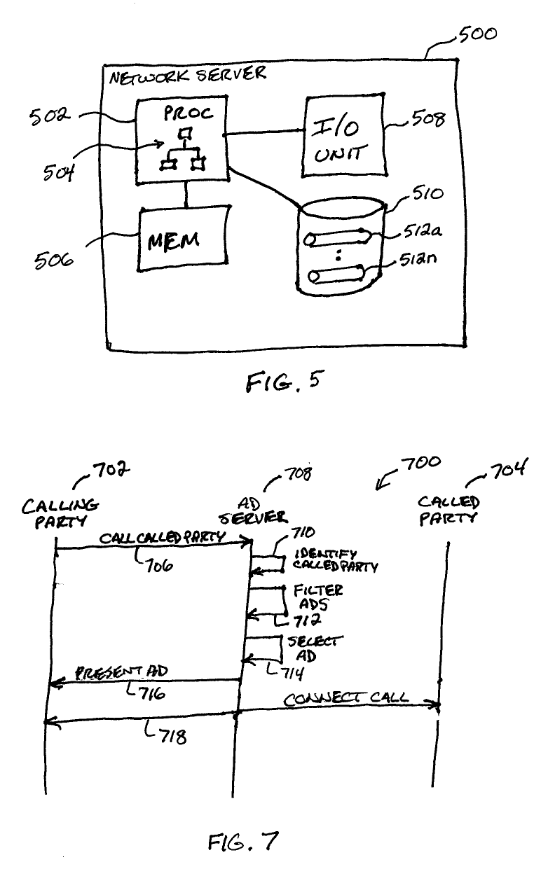

With regard to FIG. 4, a browser 400 may display a webpage 402 that enables a user of a telephone to limit ads that may be presented to the user when the user places a call to a telephone number that advertisers have bid to present ads to callers thereof. Such limitations may be desired by parents who have children who may use a home telephone so as to avoid the children hearing ads that are age inappropriate, for example. As shown, the webpage 402 may enable a user to enter a telephone number 404 and other parameters 406 to identify the types, demographics, and religion that advertisements may be identified as being identified or presentable by an advertiser. Upon completion of selections by a user, the user may submit the selected parameters using a “submit” soft-button 408 so that the selected parameters may be stored and used to limit advertisements presented to callers from the telephone number 404.

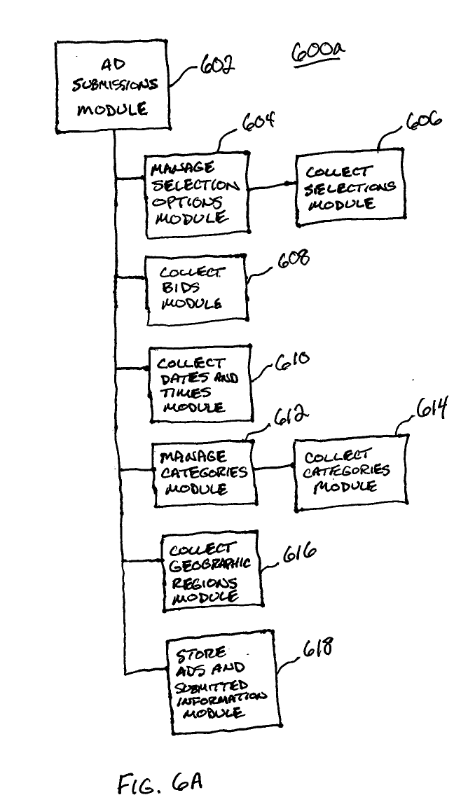

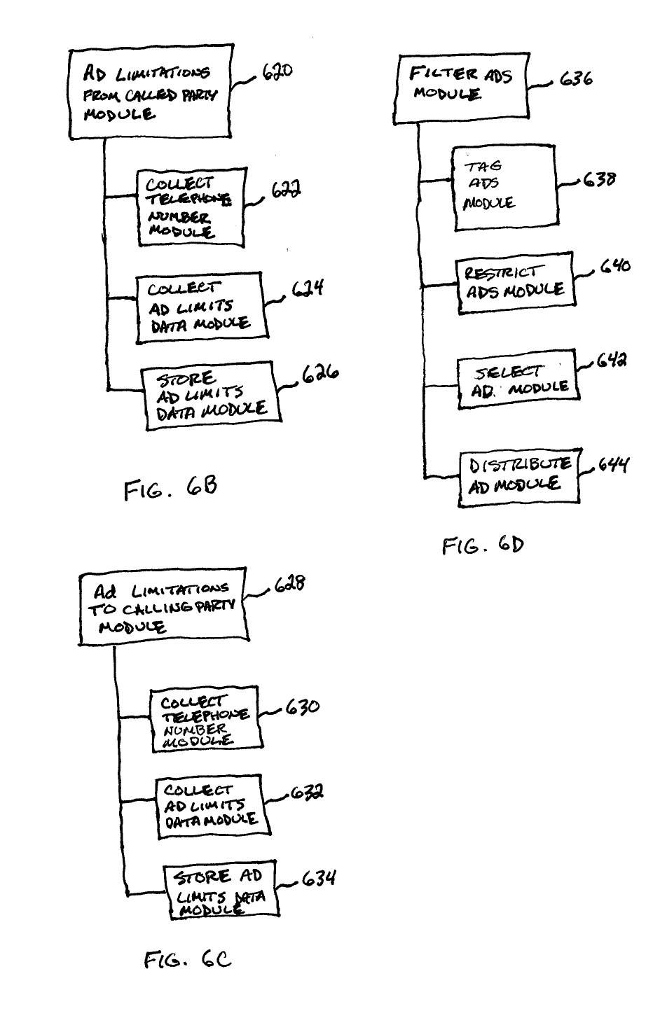

With regard to FIG. 5, a network server 500 may be used to perform the advertising functionality in accordance to the principal for the present invention. The network server 500 may be maintained by a service provider or media planner, as described with regard to FIG. 1. The network server 500 may include a processing unit 502 that may include one or more computer processors that execute software 504. The software 504 may be configured in such a way as to enable advertisers to submit advertisements and select telephone numbers that the advertisements may be delivered or presented to callers who call those telephone numbers. The processing unit 502 may be in communication with a memory 506, input/output (I/O) unit 508, and storage unit 510. The storage unit 510 may be configured to store data repositories 512a-512n (collectively 512). The memory 506 may be used to store advertisements and associated parameters. The I/O unit 508 may be configured to communicate with a network, such as the Internet or any other telecommunications network on which telephone calls may be placed. The data repository 512 may be configured to store advertisements and parameters associated with telephone numbers, individually or associated with business category, geographic regions, or otherwise. The software 504 may be configured as shown in FIGS. 6A-6D.

TABLES I-IV are illustrative data repositories 512 that may be stored in the storage unit 510. The data repositories 512 may be databases, such as relational databases or any other configuration of databases, for use in storing advertisements and respective bid and limit information submitted by an advertiser. As shown, each of the TABLES I-IV have a key to relate each ad with associated information submitted by the advertiser.

TABLE I

| | | | Ad | | Max Bid |
|---|---|---|---|---|---|
| ID | Advertiser | Advertisement | Type | Bid | Per Day |
| T7428 | General Mills | Cheerios.wav | Audio | $0.02 | $25,000.00 |
| B4712 | Nike | Justdoit.mpeg | Video | $0.04 | $100,000.00 |
| J9742 | Texaco | Fillitup.txt | Text | $0.01 | $800.00 |
| . . . | . . . | . . . | . . . | . . . | . . . |

TABLE II

| | | | | Start | |
|---|---|---|---|---|---|
| ID | Start Date | End Date | Days | Time | End Time |
| T7428 | Jun. 15, 2008 | Jul. 14, 2008 | M-F | 8 AM | 4 PM |
| B4712 | Aug. 14, 2008 | Aug. 21, | M-Su | 12 AM | 11:59 PM |
| | | 2008 | | | |
| J9742 | Jul. 1, 2008 | Jul. 31, 2008 | F-Su | 7 AM | 7 PM |
| . . . | . . . | . . . | . . . | . . . | . . . |

TABLE III

| | Cons/ | | | Geo. |
|---|---|---|---|---|
| ID | Business | Telephone # | Bus. Categ. | Region |
| T7428 | Business | — | Baby Stores | Texas |
| B4712 | Business | — | BabiesRUs; Baby Gap | U.S. |
| J9742 | Business | 617 769-1234 | Automobile Dealership | 02062 |
| . . . | . . . | . . . | . . . | . . . |

TABLE IV

| ID | Rating | Type | Demographics | Religion |
|---|---|---|---|---|
| T7428 | G | Humor | Child, Adult, F | None |
| B4712 | G | Enter., Humor. | Adult, F | None |
| J9742 | PG | Enter., Serious | Adult, M, F | None |
| . . . | . . . | . . . | . . . | . . . |

Although not shown, information selected by assignees of telephones for presenting advertisements from the telephones and receiving advertisements to the telephones may be stored in tables that are the same or analogous to those shown in TABLES I-IV. The information stored in TABLES I-IV may be utilized in selecting which advertisements are to be presented to users who call telephone numbers of businesses or consumers. As shown in TABLE III, a specific telephone number may be provided or an indicia, such as the name of a business or geographic region, may be provided that enables another table (not shown) that cross references the name of the business with each telephone number assigned to the business to be accessible so that any call to the business causes an advertisement to be presented to the caller. The indicia may also be a telephone number. Selection of which advertisement is to be presented to a caller may be performed in a variety of ways, including which advertiser is spending the most money per advertisement, which advertiser has the longest contract, which advertiser is spending the most total money, or otherwise.

With regard to FIG. 6A, modules 600a provide for an advertiser to submit bids for presenting advertisements to callers of telephone numbers. The module 600 may include an ad submissions module 602 that is configured to enable an advertiser to submit ads to be presented to callers. The ad submission module may include or communicate with a manage selection options module 604. The manage selection options module 604 may be configured to store selection options for an advertiser. The selection options may be selectable options, such as the types of telephone numbers (e.g. business, consumer, or governmental), that an advertiser may desire to associate with in advertisement. A collect selections module 606 may be in communication with the manage selection options module 604 and be configured to collect selections from an advertiser of the selection options. A collect bids module 608 may be configured to collect bid amounts for telephone call airtime. The bids may be flat fee bids, monthly bids, varying fees based on time of day or day of week, or any other bid structure that an advertiser may submit as a bid for telephone call airtime. The collect bids module 608 may further be configured to collect a maximum amount of money that an advertiser is willing to pay for telephone airtime on a per day, per week, or per month basis. Because advertisements are to be delivered based on telephone numbers called, and the number of callers to a particular telephone number may be unpredictable, an advertiser may wish to limit the amount of money that the advertiser is willing to spend, whether it be a minimum, maximum, or both over a given time period.

A collect dates and times module 610 may be configured to collect starting and ending dates that an advertiser wishes to run in an advertisement and starting and ending times that an advertiser wishes to advertise during the dates of the advertisement. Because an advertiser may wish to attract a certain audience, such as 20-something year olds, the advertiser may wish to select certain times of the day that the advertisement is to be run in order to advertise to the desired audience.

A managed categories module 612 may be configured to manage business categories that are selectable by an advertiser. The managed categories module 612 may manage categories and sub-categories within each category to narrowly define each category. For example, one category may include health and medicine and sub-categories of health and medicine may include alternative medicine, animal health, clinics and medical centers, conditions and therapies, death and dying, dentistry, drug stores and pharmacies, eye care, etc. Furthermore, within each sub-category, additional sub-categories may be available. For example, dentistry may include dentists, orthodontists, dental hygienists, dental laboratories, dental technicians, equipment and supplies, etc. It should be understood that each category may branch into multiple sub-categories and each advertiser may select one or more categories and one or more sub-categories to specifically identify which categories or sub-categories that the advertiser wishes to advertise to callers who call telephone numbers within each of the categories and/or sub-categories. In other words, an advertiser may wish to advertise to callers who have specific interests or general interests by advertising to callers of businesses that are associated with narrow or broad category levels. Each business may be categorized with a category and one or more sub-categories so that advertisements presented to callers who call businesses identified by categories and sub-categories may be properly targeted. A collect categories module 614 may be configured to collect the categories that an advertiser selects for an advertisement to be presented to callers of businesses within each of the selected categories and/or sub-categories.

A collect geographic regions module 616 may be configured to collect selections of advertisers of geographic regions in which the advertiser desires to advertise. The collect geographic regions module 616 may collect geographic regions in the form of area code, zip code, city, state, country, or any other format for identifying a geographic region in which an advertiser desires to advertise to callers who call businesses or individuals in the selected geographic regions.

A store ads and submitted information module 618 may be configured to receive the advertisements from advertisers and store the advertisements in a data repository. The store ads and submitted information module 618 may further be configured to store submitted information, such as bid information, dates and time information, category information, and geographic regions information. By storing the ads and submitted information, a filter or other software component configured to identify locations in which an advertiser desires to advertise may be utilized to limit the advertisements to those dates and times, categories, geographic regions, etc.

With regard to FIG. 6B, an ads limitation from called party module 620 may be configured to limit advertisements from a called party (i.e., a user assigned to a telephone number who receives a call) based on the called party's entries to limit advertisements from his or her telephone number (see FIG. 3). A collect telephone number module 622 may be configured to collect a telephone number from a user who desires to limit advertisements from his or her telephone number. A collect ad limits data module 624 may be a module configured to collect selected ad limitations from the user. The ad limitations may include (i) ratings, (ii) whether or not an ad may be from a competitor in the case of the user being part of a company, (iii) types of ads, (iv) demographics, and (v) religion, for example. A store ad limits data module 626 may be configured to store the collected ad limits from an assignee of the telephone number. An assignee of a telephone number may be an individual or organization to which a telecommunications service provider has assigned a telephone number. In the case of an organization, multiple telephone numbers may be assigned to the organization for individual employees and each telephone

With regard to FIG. 6C, an ad limitations to calling party module 628 may be configured to limit advertisements to a telephone number based inputs from an assignee of the telephone number (see FIG. 4). A collect telephone number module may be configured to collect a telephone number of a user who is limiting advertisements to his or her telephone number. A collect ad limits data module 632 may be configured to collect limitations of advertisements to the telephone number. The limitations being collected may include ratings, types, demographics, religion, and so forth. Each selection by a user may be collected and stored by a store ad limits data module 634. By collecting the ad limits, advertisement may be limited to the telephone number when the user makes a telephone call to a telephone number to which an advertiser has bid.

With regard to FIG. 6D, a filter ads module 636 may be configured to filter advertisements based on ad limits submitted by assignees of telephone numbers to which advertisements are presented to and from. A tag ads module 638 may be configured to associate ad limits with particular ads. For example, an advertiser who submits inputs on the various categories, such as ratings, may be associated with respective advertisements. The tags or limits may thereafter be used to limit advertisements that are presented from or to a telephone number. For example, if an ad is identified by an advertiser or service provider to be rated “R,” then an assignee of a telephone number who limits or otherwise does not approve of rated “R” advertisements to be presented from or to a telephone number will not be available to be presented when a caller calls to the telephone number of an assignee who limits “R” rated advertisements to be played from a telephone number or the assignee of a telephone number who limits “R” rated advertisements from being presented to his or her telephone number.

A select ads module 642 may be configured to select an advertisement in response to a telephone number being called. The select ad module 642 may initially determine whether a telephone number has been bid by an advertiser and, if so, whether an advertisement from a bidder meets the limitations from the assignee of the called telephone number the assignee of the calling telephone number. Upon selection of an advertisement, a distribute ad module 644 may be configured to access the advertisement from a data repository and present, distribute, or otherwise communicate the advertisement to the calling party.

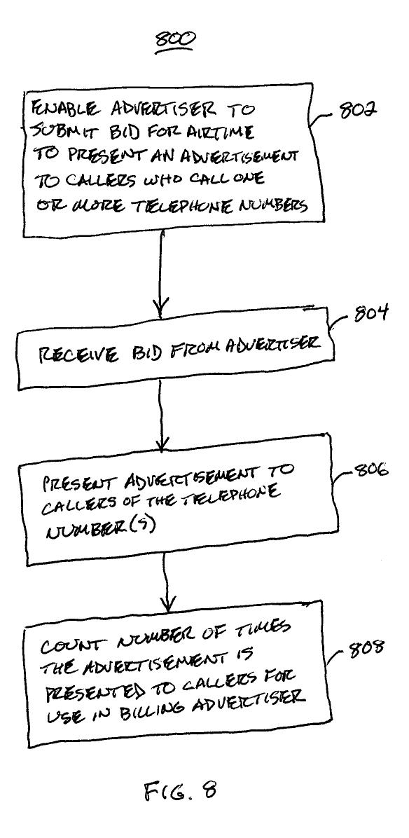

With regard to FIG. 7, an illustrative process 700 is shown to provide for presenting advertisements to a calling party 702 during a telephone call between the calling party and a called party 704. At step 706, a call may be placed from the calling party from the calling party 702 to the call party 704. The call 702 may be placed over a network in which an ad server 708 may be in communication. The ad server 708 may be the network server 500 of FIG. 5 or any other server that executes software to perform the same or analogous functionality as provided in FIGS. 6A-6B, for example. At step 710, a called party, such as called party 704, may be identified. At step 712, ads may be filtered to determine whether an advertisement that has been bid on a telephone number of the called party 704 and telephone number of the calling party 702 may be presented from and to, respectively.

At step 714, an advertisement may be selected. The advertisement may be selected based on an amount of money that has been bid on the telephone number of the call party 704 (e.g., highest bid has priority for presenting an advertisement at selected dates, days, and times), day of week that the telephone call has been placed, time of day that the telephone call has been placed, or any other limitation or submission by an advertiser.

At step 716, the selected advertisement may be presented to the calling party 702. In presenting the advertisement, the advertisement may be presented to the calling party 702 in a format that the advertisement has been submitted by the advertiser. For example, if the advertisement is a text advertisement, then a text message may be communicated to the calling party 702 if the calling party 702 is using a telephone configured to receive text messages. If the advertisement is a video advertisement, then the advertisement may be presented to the calling party 702 via a video presentation if the telephone of the calling party 702 is configured to receive and play video. Similarly, if the selected advertisement is an audio advertisement, then an advertisement may be communicated for presentation to the calling party 702. At step 718, after the advertisement has been presented to the calling party 702 at step 716, the call between the calling party 702 and called party 704 may be connected. It should be understood that although the advertisement is shown to be presented at step 716 prior to the call being connected at step 718, that the advertisement may be presented before, during, or after the telephone call has been connected between the calling party 702 and called party 704.

With regard to FIG. 8, an illustrative process 800 provides for collecting bids from advertisers to advertise to callers of telephone number(s) and present the advertisements to caller of the telephone number(s). The process 800 starts at step 802, where an advertiser is enabled to submit a bid for airtime to present an advertisement to callers who call one or more telephone numbers. The telephone numbers may be associated with businesses, individuals, or governmental agencies. The telephone numbers may be selected by an advertiser by selecting a particular telephone number, particular business, category of business, geographic region, etc. In enabling the advertiser to submit a bid, a webpage may provide entry and selection fields for the advertiser. Alternatively, an advertiser may call in an order for a telephone operator to enter the information into a computing device. At step 804, a bid may be received from an advertiser. The bid may be submit in a variety of different formats, including on a per presentation basis, flat fee basis, weekly basis, monthly basis, increasing or decreasing basis depending on a crossing advertising thresholds, or otherwise.

At step 806, the advertisement may be presented to callers of the telephone number(s). In presenting the advertisement to the telephone number(s), the advertisement may be presented in a variety of different formats, including audio message, text message, photograph message, or video message. In one embodiment, the advertisement may be presented to the caller (i.e., calling party) prior to connecting the caller to the called party. Alternatively, the advertisement may be presented to the caller during or after the telephone call. In one embodiment, the advertisement may be interactive and provide the caller with the ability to request additional information. For example, the advertisement may enable a caller to press a number key, such as ‘1,’ to receive additional information about a product or service being advertised. The additional information may be in the form of audio, text, photo, or video. In one embodiment, the additional information may be presented at the time the caller requests the additional information. Alternatively, the additional information may be communicated to the caller at a later time, such as in response to the call being disconnected.

At step 808, the number of times the advertisement is presented to callers for use in billing the advertiser may be counted. The counting may be performed over a time period selected by the user for billing purposes, such as weekly or monthly. The advertiser may be billed based on the number of times the advertisement is presented to callers.

Although described with respect to telephone calls, the principles of the present invention may more broadly be applied to actions that are performed by an individual. An action may be any physical action that an individual performs. For example, an action may include an individual driving at a certain rate of speed and an advertising message that is geared toward more aggressive or risk tolerant individuals may be communicated to the individual via a telephone or radio. As another example, an individual who drives toward a shopping area may be presented with an advertisement or coupon for shopping at a particular store or for a particular item. In yet another example, an individual who throws away a piece of trash in a trash can in a public venue may be presented with an advertisement by displaying the advertisement on an electronic display positioned on or near the trash can. Many other examples may be conceived that utilize the principles of the present invention. In each example, the ability for an advertiser to bid on airtime in response to an individual performing a physical action is made available (e.g., bid on someone throwing away a piece of trash during lunch hour on a city street).

The previous detailed description is of a small number of embodiments for implementing the invention and is not intended to be limiting in scope. The following claims set forth a number of embodiments of the invention disclosed with greater particularity.

What is claimed:

1. A method of advertising to telephones, said method comprising:
enabling an advertiser to submit a bid for airtime to present an advertisement to callers who call one or more telephone numbers;
receiving a bid from the advertiser to advertise to callers who place calls to the one or more telephone numbers;
in response to callers placing telephone calls to the one or more telephone numbers, presenting the advertisement to the callers; and
counting a number of times the advertisement is presented to the callers for use in billing the advertiser.

2. The method according to claim 1, wherein enabling the advertiser to submit a bid includes displaying a list of business categories to enable the advertiser to select a business category such that when any business being identified as being in the selected business category is called that the advertisement is presented to the callers.

3. The method according to claim 2, further comprising enabling the advertiser to select a geographic region within which businesses are to be located in order to present the advertisement to the callers.

4. The method according to claim 1, wherein enabling the advertiser to submit a bid includes providing the advertiser with selectable geographic regions where the advertisement is presented to callers who place calls therein.

5. The method according to claim 1, further comprising enabling an assignee of a telephone number to selectably limit types of advertisements that are presented to callers who call the telephone number.

6. The method according to claim 5, wherein enabling the assignee of the telephone number to selectably limit types of advertisements includes enabling the assignee to select to limit advertisements to age appropriate advertisements.

7. The method according to claim 1, further comprising enabling a caller to selectably limit types of advertisements that can be presented to the callers when placing a telephone call to telephone numbers from which advertisers have bid to present advertisements.

8. The method according to claim 1, wherein presenting the advertisement to the caller includes playing an audio advertisement to the caller prior to the caller being connected to a telephone number of the one or more telephone numbers.

9. The method according to claim 1, further comprising billing the advertiser based on the bid and how many advertisements are presented to callers.

10. The method according to claim 1, wherein enabling an advertiser to submit a bid to advertise to callers who call the one or more telephone numbers further includes enabling the advertiser to select times of day for the advertisement to be presentable to callers.

11. A system for advertising to telephones, said system comprising:
a storage unit;
at least one data repository stored in said storage unit and configured to store an advertisement and at least one parameter associated with the advertisement, the at least one parameter including an indicia associated with a telephone number; and
a processing unit in communication with said storage unit, and configured to:
enable an advertiser to submit a bid for airtime to present the advertisement to callers who call the telephone number;
receive a bid from the advertiser to advertise to callers who place calls to the telephone number;
in response to callers placing telephone calls to the telephone number, present the advertisement to the callers; and
count a number of times the advertisement is presented to the callers for use in billing the advertiser.

12. The system according to claim 11, wherein said processing unit is further configured to display a list of business categories to enable the advertiser to select a business category such that when any business being identified as being in the selected business category is called, the advertisement is presented to the callers.

13. The system according to claim 12, wherein said processing unit is further configured to enable the advertiser to select a geographic region within which businesses are to be located in order to present the advertisement to the callers.

14. The system according to claim 11, wherein, in enabling the advertiser to submit a bid, said processing unit is configured to provide the advertiser with selectable geographic regions where the advertisement is presented to callers who place calls therein.

15. The system according to claim 11, wherein said processing unit is further configured to enable an assignee of a telephone number to selectably limit types of advertisements that are presented to callers who call the telephone number.

16. The system according to claim 15, wherein, in enabling the assignee of the telephone number to selectably limit types of advertisements, said processing unit is further configured to enable the assignee to select to limit advertisements to age appropriate advertisements.

17. The system according to claim 11, wherein said processing unit is further configured to enable a caller to selectably limit types of advertisements that can be presented to the callers when placing a telephone call to telephone numbers from which advertisers have bid to present advertisements.

18. The system according to claim 11, wherein, in presenting the advertisement to the caller, said processing unit is further configured to play an audio advertisement to the caller prior to the caller being connected to a telephone number of the telephone number.

19. The system according to claim 11, wherein said processing unit is further configured to bill the advertiser based on the bid and the counted number of times the advertisement is presented to callers of the telephone number.

20. The system according to claim 11, wherein, in enabling an advertiser to submit a bid to advertise to callers who call the one or more telephone numbers, said processing unit is further configured to enable the advertiser to select times of day for the advertisement to be presentable to callers.
